(19) United States
(12) Patent Application Publication
(10) Pub. No.: US 2020/0130274 A1
(43) Pub. Date: Apr. 30, 2020

(54) SYSTEM AND METHOD FOR PREHEATING OF PORTIONS OF BUILDING MATERIAL IN AN ADDITIVE MANUFACTURING ENVIRONMENT

(71) Applicant: Materialise N.V., Leuven (BE)

(72) Inventor: Piet VAN DEN ECKER, Leuven (BE)

(21) Appl. No.: 16/624,866

(22) PCT Filed: Jul. 5, 2018
(86) PCT No.: PCT/US2018/040901

§ 371 Date: Dec. 19, 2019

Related U.S. Application Data
(60) Provisional application No. 62/528,757, filed on Jul. 5, 2017.

(51) Int. Cl. B29C 64/295; B29C 64/255; B29C 64/218; B29C 64/153; B22F 1/00

(52) U.S. Cl. CPC B29C 64/295; B29C 64/255; B33Y 30/00; B29C 64/153; B22F 1/0085; B29C 64/218

(57) ABSTRACT

A system and method for preheating of portions of building material in an additive manufacturing environment is provided. Various embodiments involve the use of a container (502A, 502B, 902, 1002, 1102) configured to preheat an aliquot of building material (502A, 502B, 900, 1002, 1102). In certain embodiments, the container (502A, 502B, 902, 1002, 1102) is configured to move along a building platform of an additive manufacturing device and further deposit building material on different sides of the building platform and further on different sides of a recoating mechanism (415A, 415B, 515, 915, 1015, 1115) of the additive manufacturing device.

### CROSS-REFERENCE TO RELATED APPLICATIONS

This application claims priority to U.S. Provisional Patent No. 62/528,757 filed on 5 Jul. 2017. The content of the provisional application is hereby incorporated by reference in its entirety.

### BACKGROUND OF THE INVENTION

### Field of the Invention

This application relates to preheating of building material for a new layer in an additive manufacturing environment. More particularly, this application relates to a system and method for preheating the portion of build material to be used for a new layer in an additive manufacturing environment and selectively directing the building material to a side of a recoater mechanism based on a position of the recoater mechanism.

### Description of the Related Technology

In the field of additive manufacturing, three dimensional solid objects are formed from a digital model. Because the manufactured objects are three dimensional, additive manufacturing is commonly referred to as three dimensional (“3D”) printing. Some techniques for additive manufacturing includes selective laser sintering (“LS”) manufacturing and metal sintering. These techniques direct a laser beam to a specified location in order to polymerize or solidify layers of building materials which are used to create the desired three dimensional (“3D”) object. The 3D object is built on a layer-by-layer basis by solidifying the layers of the building material.

Typically, the laser beam from the laser scanning only provides a portion of the energy needed to polymerize or solidify layers of the building material. The remaining portion of the energy needed is provided by generally preheating the building material to a temperature near but under the melting point of the building material before the laser scanning is performed.

Existing techniques for preheating the building material are suboptimal. Existing preheating apparatuses, such as infrared (IR) heat lamps suspended above the building material, are not well suited to heating all the various portions of the building material to an appropriate temperature for each layer of building material. For each layer of the object to be built, a new layer of building material is coated on the building platform. Typically, the recoated layer of building material is then preheated using IR heat lamps suspended above the building material. Due to the distance between the IR heat lamps and the recoated layer, for example, the preheating may be inefficient and unevenly preheat the building material.

In view of these and other problems identified by the inventor, systems and methods that improve the recoating process are needed.

### SUMMARY

In one embodiment, a system for preheating building material for an additive manufacturing device is provided. The system includes a container including a reservoir configured to hold a portion of a building material held by a building material supply of the additive manufacturing device, the reservoir having a volume less than a volume of the building material supply. The container further includes a heating mechanism coupled to the reservoir for heating the portion of the building material. The container further includes an actuation mechanism configured to deposit building material from the reservoir to at least one of a first side and a second side of a building platform of the additive manufacturing device.

In one embodiment, a method for building an object using additive manufacturing is provided. The method includes depositing a first portion of building material from a building material supply into a reservoir of a container, the reservoir having a volume less than a volume of the building material supply. The method further includes heating the first portion of building material in the container. The method further includes depositing the heated first portion of building material from the reservoir on a first side of a building platform of an additive manufacturing device on a first side of a recoating mechanism closer to a second side of the building platform. The method further includes depositing a second portion of building material from the building material supply into the reservoir. The method further includes depositing from the first side of the building platform the heated first portion of building material onto the building platform to form a first layer of building material. The method further includes scanning the first layer of building material to form a first layer of the object. The method further includes heating the second portion of building material in the container. The method further includes depositing the heated second portion of building material from the reservoir on the second side of the building platform on a second side of the recoating mechanism closer to the first side of the building platform. The method further includes depositing from the second side of the building platform the heated second portion of building material onto the building platform to form a second layer of building material. The method further includes scanning the second layer of building material to form a second layer of the object.

In one embodiment, a system for preheating building material for an additive manufacturing device is provided. The system includes means holding a portion of a building material held by a building material supply of the additive manufacturing device, the means for holding having a volume less than a volume of the building material supply. The system further includes means for heating the portion of the building material in the means for holding. The system further includes means for depositing building material from the means for holding to at least one of a first side and a second side of a building platform of the additive manufacturing device.

### BRIEF DESCRIPTION OF THE DRAWINGS

FIG. 1 is an example of a system for designing and manufacturing 3D objects.

FIG. 2 illustrates a functional block diagram of one example of the computer shown in FIG. 1.

FIG. 3 shows a high level process for manufacturing a 3D object using.

FIG. 4A is an example of an additive manufacturing apparatus with a recoating mechanism.

FIG. 4B is another example of an additive manufacturing apparatus with a recoating mechanism.

FIG. 5A illustrates an exemplary additive manufacturing apparatus for generating a three-dimensional (3-D) object configured to preheat an aliquot of building material prior to deposition on the building platform according to the systems and methods disclosed herein.

FIG. 5B illustrates another exemplary additive manufacturing apparatus for generating a three-dimensional (3-D) object configured to preheat an aliquot of building material prior to deposition on the building platform according to the systems and methods disclosed herein.

FIGS. 6A-6G illustrate example states of portions of the additive manufacturing apparatus of FIG. 5A.

FIG. 7 is a flowchart of an example process for building of layers of an object using an additive manufacturing apparatus according to the systems and methods disclosed herein.

FIGS. 8A-8C illustrate exemplary powder removal mechanisms in an additive manufacturing apparatus.

FIGS. 9A-9B illustrate portions of an additive manufacturing apparatus configured to preheat an aliquot of building material and reduce accumulation of building material when used.

FIG. 10 illustrates an embodiment of a portion of an additive manufacturing apparatus configured for moving building material.

FIGS. 11A-11B illustrate an embodiment of a portion of an additive manufacturing apparatus configured for shaking building material.

### DETAILED DESCRIPTION OF CERTAIN INVENTIVE EMBODIMENTS

Systems and methods disclosed herein include mechanisms for preheating an aliquot of building material (portion of the entire building material) at an additive manufacturing device that is used for recoating a building platform of the additive manufacturing device before depositing the building material on the building platform of the additive manufacturing device. For example, in some embodiments, the additive manufacturing device includes a container configured to hold the aliquot of building material. The container may receive the aliquot of building material from a building material supply mechanism that holds a larger portion of the building material. In some embodiments, the container further includes or is coupled to a heating mechanism that heats the contents of the container. For example, the container may include or be coupled to any suitable heating mechanism (e.g., heating coils, IR heaters, Peltier elements, etc.). In some embodiments, the container further includes or is coupled to a cooling mechanism that cools the contents of the container. For example, the container may include or be coupled to any suitable cooling mechanism (e.g., heating pump, Peltier elements, etc.). Accordingly, the aliquot of building material can be set to an appropriate temperature (e.g., preheated) separately form the larger portion of the building material in a container prior to deposition on the building platform. In certain embodiments, the aliquot of building material is preheated to a temperature above an ambient temperature and below a transition point (e.g., melting point) of the building material. In certain embodiments, the aliquot of building material is preheated to a temperature based on a type of the material, one or more desired properties of a final product built from the build material, a design of the final product, etc.

The container may further be configured to deposit the preheated building material on a side of the building platform, and the preheated building material may be pushed across the building platform by a recoating mechanism, such as a leveling drum or roller. In certain embodiments, the container (e.g., a reservoir of the container) has a minimum volume sufficient to hold enough build material for a single layer of building material for the additive manufacturing device. In certain embodiments, the container has a volume sufficient to hold more building material (e.g., 0-30% more) than needed for a single layer, such as to keep additional building material preheated. The volume of the reservoir is less than (e.g., significantly less than a volume of the entire build material held at the additive manufacturing device (e.g., less than a supply mechanism such as a powder supply). In certain embodiments, a mechanism to tap or shake (e.g., motor, actuator, etc.) the container may be included in the container or coupled to the container, such as to help prevent or fix sticking of powder in the container.

In certain embodiments, preheating the aliquot of building material instead of the entire portion of the building material may provide certain advantages. For example, preheating only an aliquot may mean that a smaller volume of building material can be preheated at a time, and the temperature may be easier to control. In addition, the time and energy for heating an aliquot is reduced as opposed to heating the entire volume of building material. Further, preheating the building material in the container with elements coupled to or integrated in the container for setting the temperature of the building material may be more efficient and evenly set the temperature of the building material than other heating mechanisms. In addition, by preheating the building material prior to pushing it across the building platform, the building material may be easier to push to form a layer of building material. In another example, preheating the building material may increase an overall quality of an object formed using the building material.

In certain embodiments, to coat the building platform for multiple layers, existing techniques utilize multiple feeding mechanisms for applying building material to the building platform. In particular, to coat a building platform, building material may be applied on one side of the building platform by one feeding mechanism, and then a recoating mechanism (e.g., recoater, blade recoater, roller, etc.) may push the building material over the building platform to create a layer by moving from the first side to the other side of the building platform. Accordingly, another feeding mechanism applies building material on the other side of the building platform, and the recoating mechanism may push the building material over the building platform to create a layer by moving from the other side back to the first side of the building platform. In certain embodiments, two containers are included in an additive manufacturing device to preheat an aliquot of building material. For example, the containers may be positioned at either side of the additive manufacturing device, and be configured to receive building material from separate feeding mechanisms, preheat the building material, and deposit on the respective side of the additive manufacturing device.

Inclusion of multiple feeding mechanisms may be expensive. Accordingly, in some embodiments, the container is further designed to receive building material from a single building material supply mechanism and selectively deposit building material in multiple locations on the building platform. Further, in some embodiments, the container is designed to deposit the building material on multiple sides of a recoating mechanism of the additive manufacturing device. Accordingly, in some embodiments, the container can receive building material from a single building material supply mechanism, preheat the building material, deposit the preheated building material on a first side of the building platform on a first side of a recoating mechanism to allow the recoating mechanism to coat the building platform in a first direction, and further deposit the preheated building material on a second side of the building platform on a second side of the recoating mechanism to allow the recoating mechanism to coat the building platform in a second direction. Advantageously, building material can be properly preheated, a single building material supply can be used lowering complexity and cost, and recoating can still be performed in multiple directions.

Though some embodiments described herein are described with respect to selective laser sintering techniques using powder as a building material, the described system and methods may also be used with certain other additive manufacturing techniques and/or certain other building materials as would be understood by one of skill in the art.

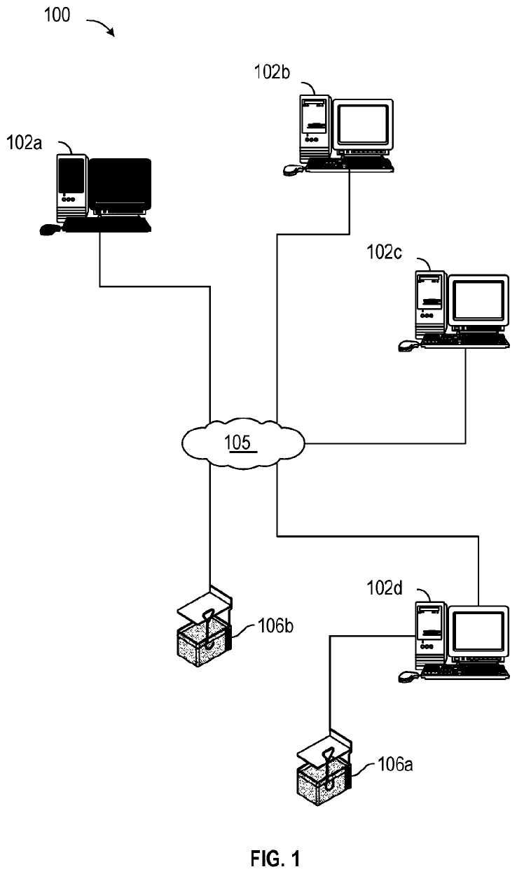

Embodiments of the invention may be practiced within a system for designing and manufacturing 3D objects. Turning to FIG. 1, an example of a computer environment suitable for the implementation of 3D object design and manufacturing is shown. The environment includes a system 100. The system 100 includes one or more computers 102a-102d, which can be, for example, any workstation, server, or other computing device capable of processing information. In some embodiments, each of the computers 102a-102d can be connected, by any suitable communications technology (e.g., an internet protocol), to a network 105 (e.g., the Internet). Accordingly, the computers 102a-102d may transmit and receive information (e.g., software, digital representations of 3-D objects, commands or instructions to operate an additive manufacturing device, etc.) between each other via the network 105.

The system 100 further includes one or more additive manufacturing devices (e.g., 3-D printers) 106a-106b. As shown the additive manufacturing device 106a is directly connected to a computer 102d (and through computer 102d connected to computers 102a-102c via the network 105) and additive manufacturing device 106b is connected to the computers 102a-102d via the network 105. Accordingly, one of skill in the art will understand that an additive manufacturing device 106 may be directly connected to a computer 102, connected to a computer 102 via a network 105, and/or connected to a computer 102 via another computer 102 and the network 105.

It should be noted that though the system 100 is described with respect to a network and one or more computers, the techniques described herein also apply to a single computer 102, which may be directly connected to an additive manufacturing device 106.

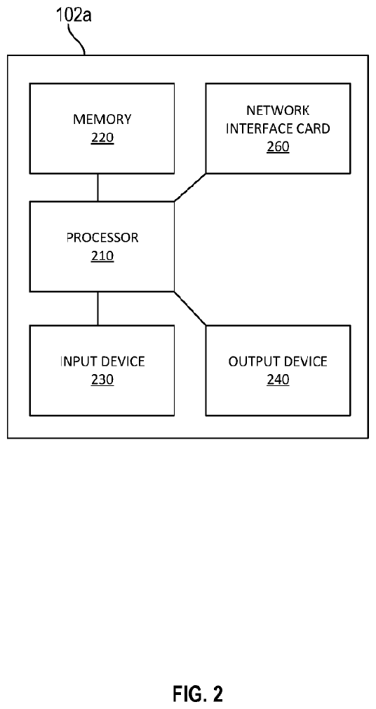

FIG. 2 illustrates a functional block diagram of one example of a computer of FIG. 1. The computer 102a includes a processor 210 in data communication with a memory 220, an input device 230, and an output device 240. In some embodiments, the processor is further in data communication with an optional network interface card 260. Although described separately, it is to be appreciated that functional blocks described with respect to the computer 102a need not be separate structural elements. For example, the processor 210 and memory 220 may be embodied in a single chip.

The processor 210 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 210 can be coupled, via one or more buses, to read information from or write information to memory 220. The processor may additionally, or in the alternative, contain memory, such as processor registers. The memory 220 can include processor cache, including a multi-level hierarchical cache in which different levels have different capacities and access speeds. The memory 220 can also include random access memory (RAM), other volatile storage devices, or non-volatile storage devices. The storage can include hard drives, optical discs, such as compact discs (CDs) or digital video discs (DVDs), flash memory, floppy discs, magnetic tape, and Zip drives.

The processor 210 also may be coupled to an input device 230 and an output device 240 for, respectively, receiving input from and providing output to a user of the computer 102a. Suitable input devices include, but are not limited to, a keyboard, buttons, keys, switches, a pointing device, a mouse, a joystick, a remote control, an infrared detector, a bar code reader, a scanner, a video camera (possibly coupled with video processing software to, e.g., detect hand gestures or facial gestures), a motion detector, or a microphone (possibly coupled to audio processing software to, e.g., detect voice commands). Suitable output devices include, but are not limited to, visual output devices, including displays and printers, audio output devices, including speakers, headphones, earphones, and alarms, additive manufacturing devices, and haptic output devices.

The processor 210 further may be coupled to a network interface card 260. The network interface card 260 prepares data generated by the processor 210 for transmission via a network according to one or more data transmission protocols. The network interface card 260 also decodes data received via a network according to one or more data transmission protocols. The network interface card 260 can include a transmitter, receiver, or both. In other embodiments, the transmitter and receiver can be two separate components. The network interface card 260, can be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein.

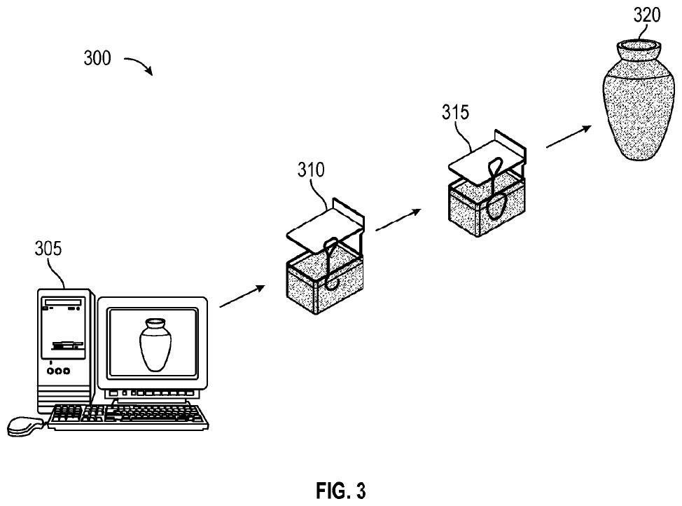

FIG. 3 illustrates a process 300 for manufacturing a 3-D object or device. As shown, at a step 305, a digital representation of the object is designed using a computer, such as the computer 102a. For example, 2-D or 3-D data may be input to the computer 102a for aiding in designing the digital representation of the 3-D object. Continuing at a step 310, information is sent from the computer 102a to an additive manufacturing device, such as additive manufacturing device 106, and the device 106 commences the manufacturing process in accordance with the received information. At a step 315, the additive manufacturing device 106 continues manufacturing the 3-D object using suitable materials, such as a polymer or metal powder. Further, at a step 320, the 3-D object is generated.

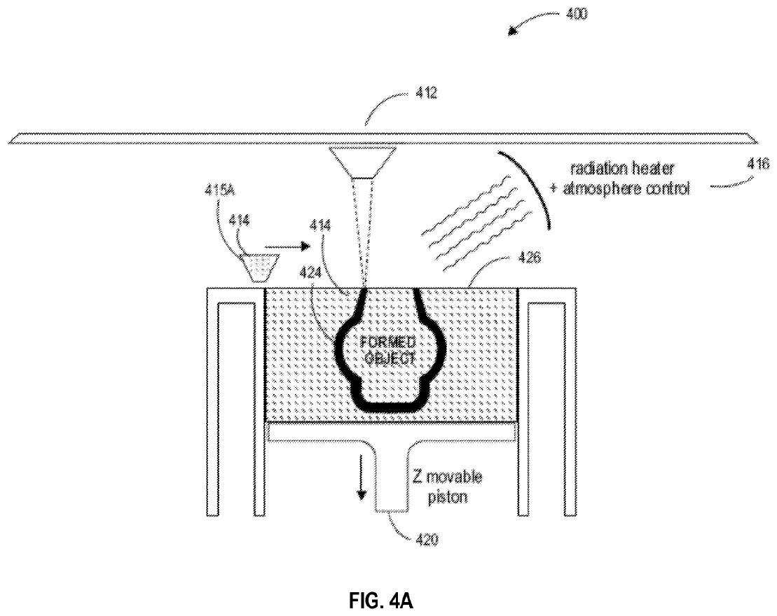

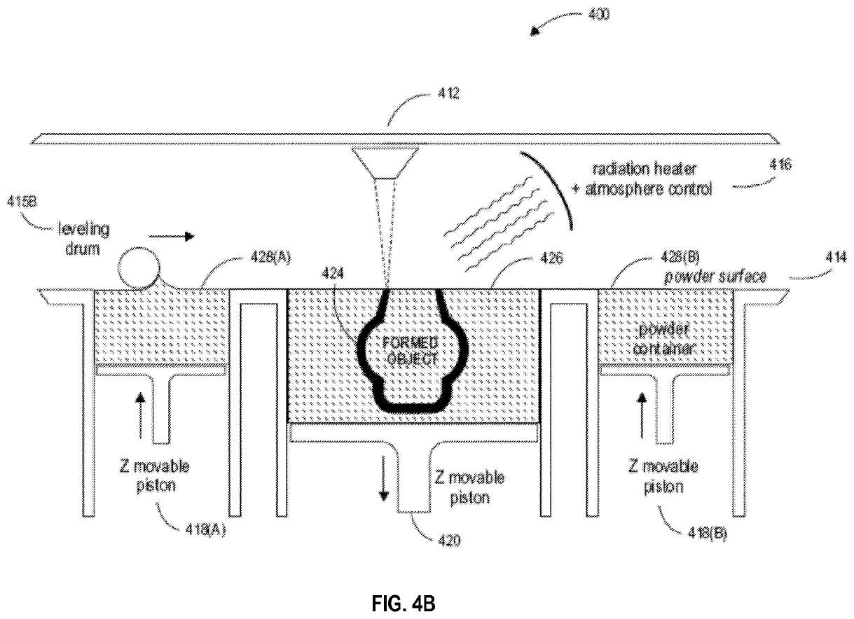

FIG. 4A illustrates an exemplary additive manufacturing apparatus 400 for generating a three-dimensional (3-D) object. In this example, the additive manufacturing apparatus 400 is a laser sintering device. The laser sintering device 400 may be used to generate one or more 3D objects layer by layer. The laser sintering device 400, for example, may utilize a powder (e.g., metal, polymer, etc.), such as the powder 414, to build an object a layer at a time as part of a build process.

Successive powder layers are spread on top of each other using, for example, a recoating mechanism 415A (e.g., a recoater blade). The recoating mechanism 415A deposits powder for a layer as it moves across the build area, for example in the direction shown, or in the opposite direction if the recoating mechanism 415A is starting from the other side of the build area, such as for another layer of the build. After deposition, a computer-controlled CO2 laser beam scans the surface and selectively binds together the powder particles of the corresponding cross section of the product. In some embodiments, the laser scanning device 412 is an X-Y moveable infrared laser source. As such, the laser source can be moved along an X axis and along a Y axis in order to direct its beam to a specific location of the top most layer of powder. Alternatively, in some embodiments, the laser scanning device 412 may comprise a laser scanner which receives a laser beam from a stationary laser source, and deflects it over moveable mirrors to direct the beam to a specified location in the working area of the device. During laser exposure, the powder temperature rises above the material (e.g., glass, polymer, metal) transition point after which adjacent particles flow together to create the 3D object. The device 400 may also optionally include a radiation heater (e.g., an infrared lamp) and/or atmosphere control device 416. The radiation heater may be used to preheat the powder between the recoating of a new powder layer and the scanning of that layer. In some embodiments, the radiation heater may be omitted. The atmosphere control device may be used throughout the process to avoid undesired scenarios such as, for example, powder oxidation. As discussed, use of the radiation heater alone may not be optimal.

In some other embodiments, such as shown with respect to FIG. 4B, a recoating mechanism 415B (e.g., a leveling drum/roller) may be used instead of the recoating mechanism 415A. Accordingly, the powder may be distributed using one or more moveable pistons 418(a) and 418(b) which push powder from a powder container 428(a) and 428(b) into a reservoir 426 which holds the formed object 424. The depth of the reservoir, in turn, is also controlled by a moveable piston 420, which increases the depth of the reservoir 426 via downward movement as additional powder is moved from the powder containers 428(a) and 428(b) in to the reservoir 426. The recoating mechanism 415, pushes or rolls the powder from the powder container 428(a) and 428(b) into the reservoir 426. Similar to the embodiment shown in FIG. 4A, the embodiment in FIG. 4B may use the radiation heater alone for preheating the powder between recoating and scanning of a layer, which may not be optimal. Further, as shown, the recoating mechanism 415B requires two separate building material supplies, shown as powder containers 428(a) and 428(b), which may not be optimal.

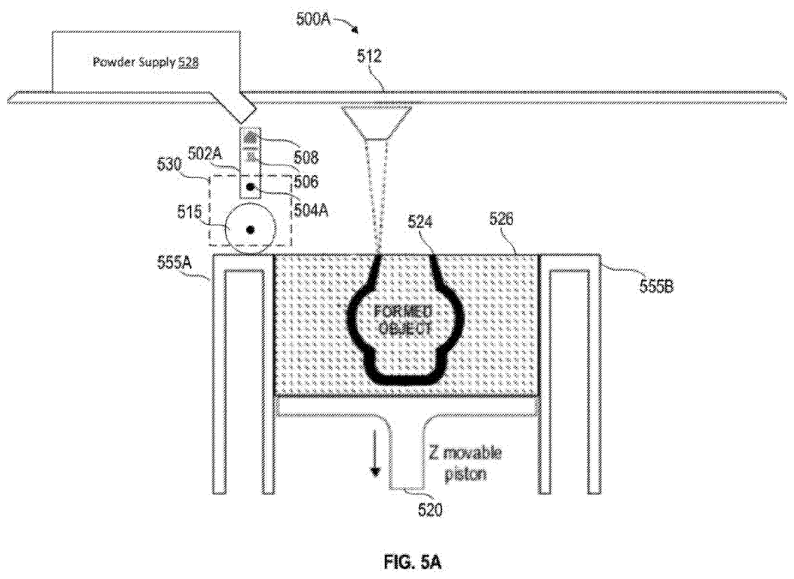

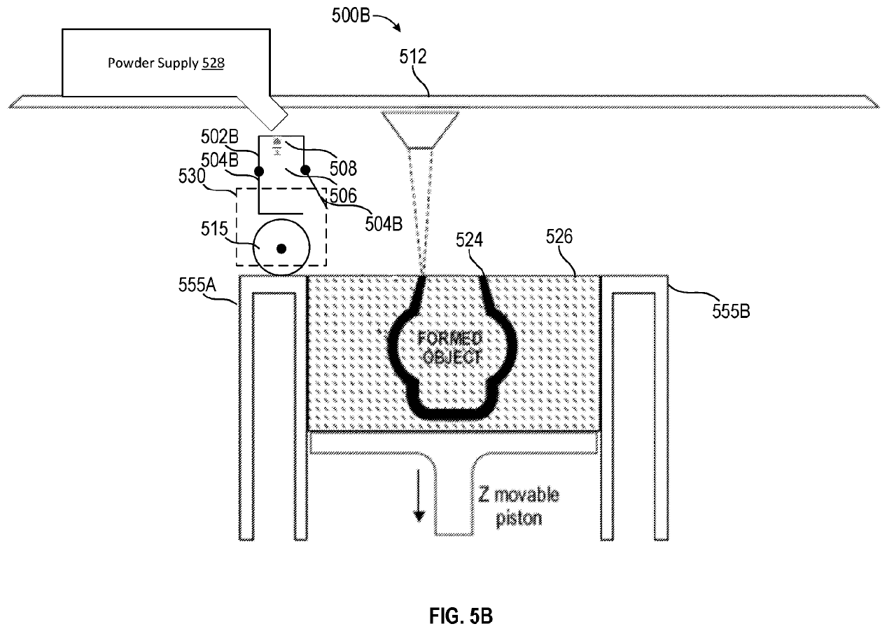

FIG. 5A illustrates an exemplary additive manufacturing apparatus 500A for generating a three-dimensional (3-D) object configured to preheat an aliquot of building material prior to deposition on the building platform. In certain embodiments, the additive manufacturing apparatus 500A is a laser sintering device and the building material is a powder. The additive manufacturing apparatus 500A may be used to generate one or more 3D objects layer by layer.

As shown, additive manufacturing apparatus 500A includes a laser scanning device 512, which may be similar to laser scanning device 412. The additive manufacturing apparatus 500A further includes a moveable piston 520, which may be similar to moveable piston 420. The additive manufacturing apparatus 500A further includes a recoating mechanism 515 (e.g., a leveling drum/roller), which may be similar to a recoating mechanism 415B. Similar to as discussed with respect to additive manufacturing apparatus 400 as shown in FIG. 4B, recoating mechanism 515, pushes or rolls powder into the reservoir 526 to form a layer of building material, and then laser scanning device 412 scans the surface of the building material to build an object 524 on a layer by layer basis. In certain embodiments, recoating mechanism 515 may push or roll powder into the reservoir 526 from either side of the building platform of the additive manufacturing apparatus 500A. The recoating mechanism may push or roll powder in a direction from the front area or the rear area of the building platform, or in a circular motion over the building platform. For example, recoating mechanism 515 may push or roll powder into the reservoir 526 from a first side 555A of the building platform to a second side 555B of building platform, and also in the reverse (from second side 555B to first side 555A). In certain embodiments, recoating mechanism 515 may push or roll powder into the reservoir 526 from alternating sides or areas for layers sequentially, so each time the recoating mechanism 515 moves from one side to another, a new layer of building material is coated on the building platform.

In certain embodiments, additive manufacturing apparatus 500A includes a container 502A positioned above the recoating mechanism 515. In some embodiments, as shown, container 502A is mounted above the recoating mechanism 515 such that container 502A moves with recoating mechanism 515. For example, in some embodiments, container 502A is mounted in a frame 530 made of flanges including an axle for the recoating mechanism 515 to rotate with respect to the frame 530. In certain embodiments, the frame may comprise structural components other than a flange, such as a plate on which the axles are mounted, walls, or other mechanical means for holding parts of the container together or rotating with respect to the recoating mechanism. In some embodiments, as shown in FIG. 5A, the container 502A is further mounted to allow the container 502A to tip to either side of the recoating mechanism 515 and deposit building material on either side of recoating mechanism 515. For example, the container 502A may be mounted on an axle 504A allowing the container 502A to tip to either side of the recoating mechanism 515. The container 502A may be tipped using an actuation mechanism (e.g., by an actuator or motor at axle 504A).

In some embodiments, the container 502A includes a heating mechanism 506 (and optionally a cooling mechanism (not shown)), as discussed. The container 502A may further include a tapping or shaking mechanism, as discussed. The container 502A further includes a reservoir 508 (e.g., positioned at a tip or top portion of the container 502A above heating mechanism 506. In certain aspects, the reservoir 508 is configured to hold an aliquot of building material as discussed. The additive manufacturing apparatus 500A further includes a powder supply 528 configured to deposit powder in the reservoir 508.

In other embodiments, additive manufacturing apparatus 500A includes two containers 502A mounted on either side of the building platform (not shown) that do not move with recoating mechanism 515 (e.g., they are fixed in place), as discussed. In some such embodiments, additive manufacturing apparatus 500A includes two powder supplies 528 (not shown), one for each container 502A.

In some embodiments, as shown in FIG. 5B with respect to the additive manufacturing apparatus 500B, instead of container 502A, the additive manufacturing apparatus 500B includes a container 502B. Instead of tipping to deposit material on either side of recoating mechanism 515, container 502B includes one or more slots or door mechanisms 504B that selectively open to deposit building material on either side of recoating mechanism 515. The slots 504B are shown near the bottom of container 502B, but may be in any suitable location. The slots 504B may be opened using an actuation mechanism (e.g., by an actuator or motor). Further, in certain aspects, other suitable mechanisms may be used, such as a single mechanism that can open to either side of container 502B. Various components of additive manufacturing apparatus 500A/500B may be controlled by a computing device such as computing device 102a.

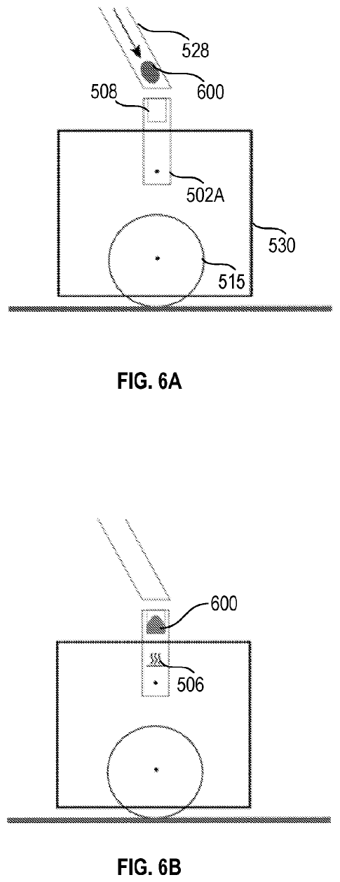

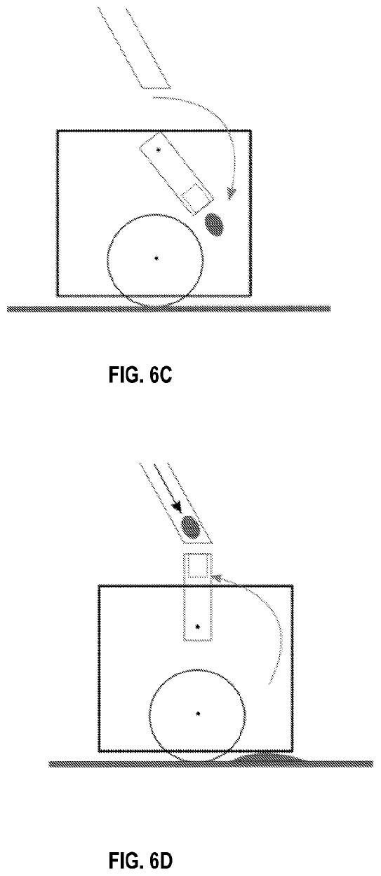

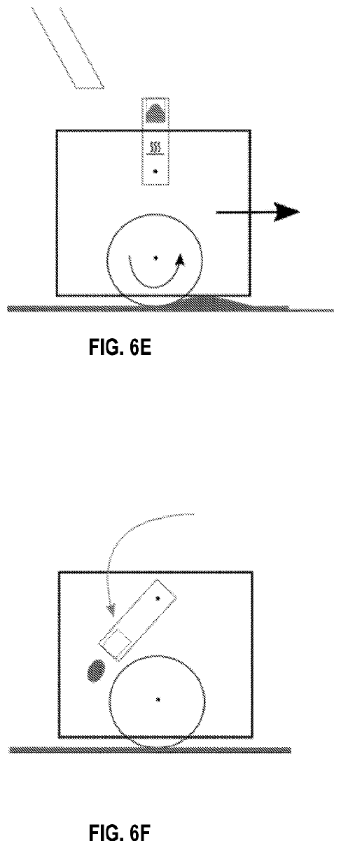

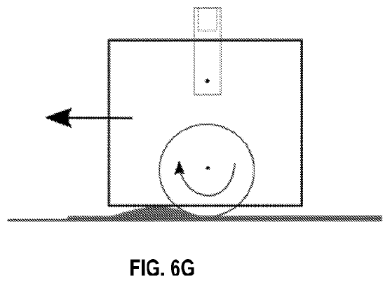

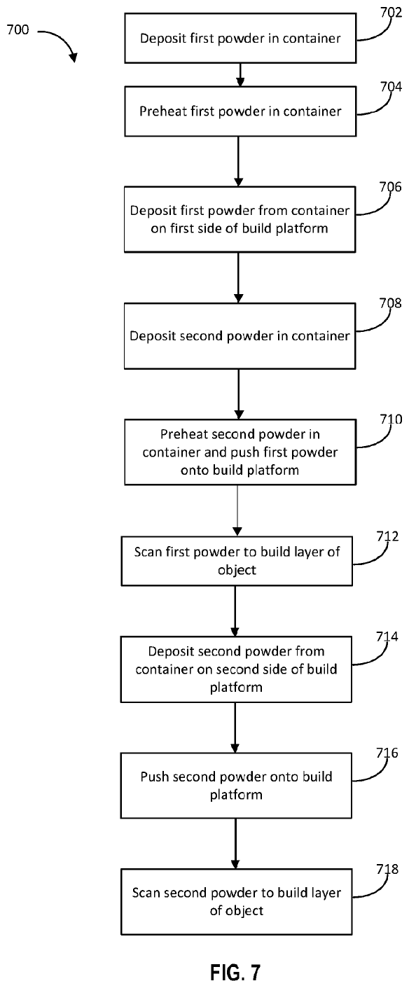

An example of a process 700 for building of layers of an object 524 using additive manufacturing apparatus 500A is further described with respect to FIGS. 6A-6G, which illustrate states of portions of the additive manufacturing apparatus 500A, and with respect to FIG. 7 which is a flowchart of the process 700 for building of layers of an object 524 using an additive manufacturing apparatus according to the systems and methods disclosed herein.

At 702, at side 555A of additive manufacturing apparatus 500A, powder supply 528 deposits an aliquot of powder 600 into reservoir 508 of container 502A, when the container is not tipped (e.g., in an up-right position), as shown in FIG. 6A. Further, at 704, heating mechanism 506 (and optionally a cooling mechanism) preheats powder 600 to a desired temperature as discussed, as shown in FIG. 6B. It should be noted that steps 702 and 704 may be performed in parallel with or while the surface of a deposited layer of building material on the building platform is scanned by laser scanning device 512 to build a layer of object 524.

At 706, the container 502A is tipped to a first tipped position (e.g., with reservoir 508 being closer to the side of recoating mechanism 515 that is closer to side 555B) to deposit powder on the building platform at side 555A on the side of recoating mechanism 515 that is closer to side 555B, as shown in FIG. 6C. Continuing, at 708, the container 502A is returned to the up-right position and powder supply 528 deposits another aliquot of powder 600 into reservoir 508 of container 502A, as shown in FIG. 6D. It should be noted that steps 706 and 708 may also be performed in parallel with or while the surface of a deposited layer of building material on the building platform is scanned by laser scanning device 512 to build a layer of object 524.

At 710, the aliquot of powder 600 in reservoir 508 is preheated by heating mechanism 506 (and optionally a cooling mechanism) to a desired temperature as discussed as recoating mechanism 515 moves from side 555A to side 555B (along with container 502A) to deposit (e.g., push or roll) a layer of building material (corresponding to the aliquot of building material deposited on the building platform at 706) on the building platform of additive manufacturing apparatus 500A, as shown in FIG. 6E. It should be noted that the preheating portion of step 710 may be performed before depositing the layer of building material on the building platform, such as in parallel with or while the surface of a deposited layer of building material on the building platform is scanned by laser scanning device 512 to build a layer of object 524. At 712, the surface of the deposited layer of building material is scanned by laser scanning device 512 to build a layer of object 524. In certain aspects, instead of preheating the aliquot of powder 600 at 710, the aliquot of powder 600 may be preheated in parallel or after 712.

At 714, the container 502A is tipped to a second tipped position (e.g., with reservoir 508 being closer to the side of recoating mechanism 515 that is closer to side 555A) to deposit powder on the building platform at side 555B on the side of recoating mechanism 515 that is closer to side 555A, as shown in FIG. 6F. At 716, recoating mechanism 515 moves from side 555B to side 555A (along with container 502A) to deposit (e.g., push or roll) a layer of building material (corresponding to the aliquot of building material deposited on the building platform at 714) on the building platform of additive manufacturing apparatus 500A, as shown in FIG. 6G. At 718, the surface of the deposited layer of building material is scanned by laser scanning device 512 to build a layer of object 524. Process 700 may then be repeated until each layer of object 524 is built.

In certain aspects, the additive manufacturing apparatus comprises a powder removal mechanism to aid in removal of powder from the container. Powder may stick in the container, for example, after it has been heated, or because certain powder compositions are prone to clumping or sticking. When powder collects in the container, it may be difficult to deposit the entire aliquot from the reservoir which may lead to formation of a non-uniform layer of building material after recoating.

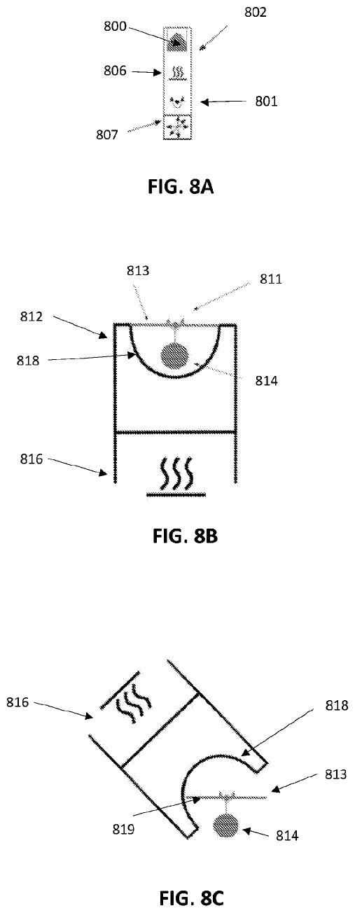

FIG. 8A shows an exemplary powder removal mechanism 807, which may be a part of the container 802. The container 802 may be configured to preheat powder in the additive manufacturing apparatus, similar to container 502 in FIGS. 5A and 5B. An aliquot of powder 800 may be heated by a heating mechanism 806 in the container, then shaken or tapped out of the container 802 when the container is tipped over or rotated around its axis 801. The powder removal mechanism may be built into the container 802. In some embodiments, the powder removal mechanism is separate from the container 802, for example, a tapper or a shaker that contacts an exterior portion of the container. The powder removal mechanism may be an agitating means such as a shaker or vibratory mechanism that shakes powder out of the container onto the build platform. The powder removal mechanism may be motorized. In certain embodiments, the powder removal mechanism may be an arm that taps or strikes the side of the container in order to shake the powder out.

FIG. 8B shows a container 812 including a heating mechanism 816 and another exemplary powder removal mechanism comprising a scraper 813 and a counter weight 814. The scraper 813 is configured to scrape or push an aliquot of powder (not shown) out of a reservoir 818 when the scraper rotates around an axis 811. FIG. 8C shows the container when it has been tipped over to dump out the powder. A first end 819 of the scraper 813 moves along the interior of the reservoir 818 and scrapes most or all powder out. The movement of the scraper may be aided by the counterweight 814.

Accordingly, the powder removal mechanism may be configured as a paddle, spoon, scraper, crumber, brush, or bar that scoops, scrapes, or pushes the powder out of the container. In some embodiments, compressed gas such as air or nitrogen may be used to blow the powder out of the container. A further embodiment of a container configured for powder removal comprises a double-walled structure with an inner wall and an outer wall. Gas or fluid may be passed continuously or at intervals through a gap between the inner wall and the outer wall. Powder may be contained within the inner wall, which may be configured to receive the stream of gas or fluid and direct it towards the powder, thereby pushing the powder away from the inner wall and out of the container. An exemplary inner wall may comprise a porous structure through which gas or liquid may flow. In other embodiments, powder may be fluidized using a stream of gas or fluid that prevents clumping or collecting in corners or seams of the container. Fluids may be flushed into the container in order to wash excess powder out. In some embodiments, magnetic or electrostatic (such as anti-static) forces may be used to repel powder from the tipper. For example, if both the powder and the container are charged, or if a charge may be applied to either or both the powder and the container, then the walls of the container may repel the powder.

At least one surface of the container that makes contact with powder may be configured to reduce sticking or accumulation of powder. For example, the surface roughness value may be as low as possible, with no or few surface cavities or openings into which the powder may collect. The adhesion between the surface of the container and the powder may be minimized by polishing the surface to smoothness, or by applying an anti-stick coating. In some embodiments, the surface of the container may be configured with channels or grooves to direct the flow of the powder in or out of the container.

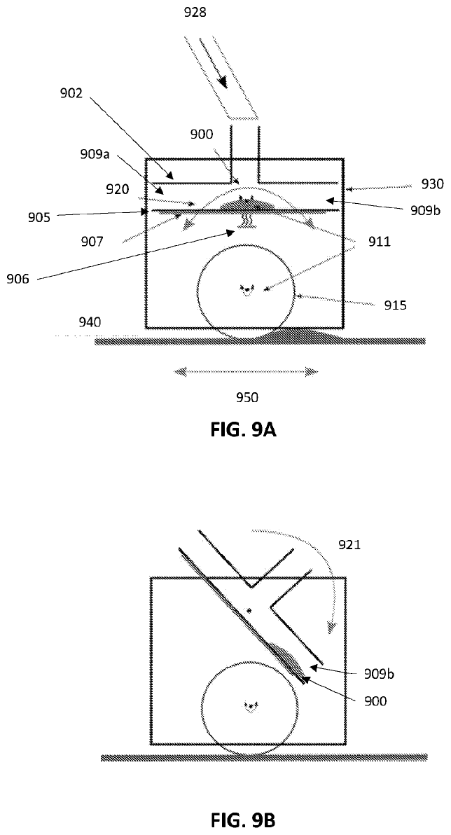

Features in other exemplary containers may be configured to minimize or reduce sticking of powder. FIG. 9A shows a container 902 comprising a bottom 905 on which an aliquot of powder 900 has been deposited. The container may further comprise a heated surface 907 which transfers heat from a heating mechanism 906 to the bottom 905 and the powder 900. Alternatively, the bottom 905 may be heated directly. The container may comprise open ends 909a and 909b, out of which the powder may be deposited beside the recoating mechanism 915 on the powder bed 940 when the container 902 is rotated in a tipping movement indicated by a double arrow 920. The rotational axes 911 of the container 902 and the recoating mechanism 915 are indicated, as are the directions 950 in which the recoater may move. The recoater frame 930 and the powder supply 928 are also indicated. FIG. 9B shows the same container 902, now rotated in the direction of the arrow 921, whereby the aliquot of powder 900 falls out of the open end 909b of the container 902. Because the container 902 comprises open ends and a substantially flat bottom, there are few or no edges or corners in the container where powder may accumulate. In some embodiments, powder may slide easily from the bottom 905, so that the container 902 may be rotated only slightly, for example, less than 90 degrees or less than 45 degrees from its resting position, in order to deposit the aliquot of powder 900 onto the powder bed 940. The container 902 may comprise at least one open end, or may comprise doors or flaps that open as or after the container 902 rotates.

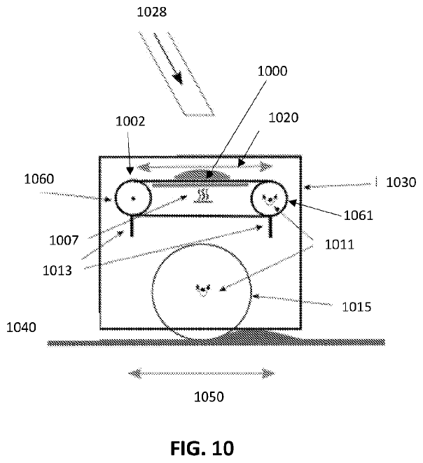

FIG. 10 shows an exemplary container 1002 comprising a conveyer belt 1060. An aliquot of powder 1000 has been deposited from the powder supply 1028 onto the conveyer belt 1060, which may move in either direction indicated by the double arrow 1020. The container 1002 may further comprise a heated surface 1007 which heats the section of the conveyer belt 1060 where the aliquot of powder 1000 is positioned. The rotational axes 1011 of the recoater mechanism 1015 and a rotating element 1061 on the conveyer belt 1060 are indicated. The container may comprise a scraper 1013 that clears powder from one or more sections of the conveyer belt 1060. As the conveyer belt 1060 rotates, the aliquot of powder 1000 falls beside the recoating mechanism 1015. The recoating mechanism moves in either direction indicated by the double arrow 1050 to spread the powder over the powder bed 1040. A recoater frame 1030 is also indicated.

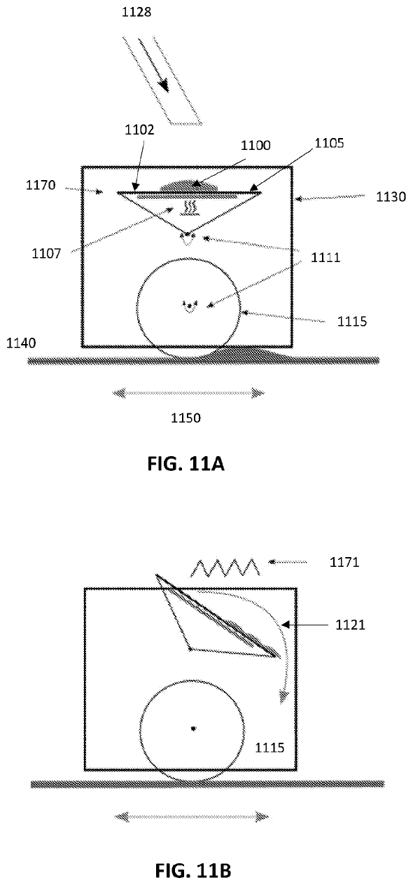

FIG. 11A shows a further example of a container 1102, comprising a bottom 1105 on which an aliquot of powder 1100 has been deposited from the powder supply 1128. The container may comprise a heated surface 1170, which transfers heat to the bottom 1105 and the aliquot of powder 1100. The container comprises as vibrating surface 1170, which may be built into the bottom 1105 or may be a separate mechanism. The rotational axes 1111 of the recoating mechanism 1115 and the container 1102 are indicated. FIG. 11B shows the same container 1102, now rotated along its rotational axis in the direction of arrow 1121 so that the aliquot of powder falls beside the recoating mechanism. Surface vibrations 1171 may aid in providing an even and complete removal of powder from the bottom 1105.

Powder may stick or accumulate in a powder supply, so that a complete aliquot of powder does not fall into the container. To increase the powder distribution from the powder supply, the additive manufacturing apparatus may comprise a powder supply mechanism, for example a powder hopper that has a vibrating surface or plate against which a portion of the powder rests. The vibrating surface or plate may push a small amount powder out of the powder supply and into the container.

Various embodiments disclosed herein provide for the use of a computer control system. A skilled artisan will readily appreciate that these embodiments may be implemented using numerous different types of computing devices, including both general purpose and/or special purpose computing system environments or configurations. Examples of well-known computing systems, environments, and/or configurations that may be suitable for use in connection with the embodiments set forth above may include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like. These devices may include stored instructions, which, when executed by a microprocessor in the computing device, cause the computer device to perform specified actions to carry out the instructions. As used herein, instructions refer to computer-implemented steps for processing information in the system. Instructions can be implemented in software, firmware or hardware and include any type of programmed step undertaken by components of the system.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

Aspects and embodiments of the inventions disclosed herein may be implemented as a method, apparatus or article of manufacture using standard programming or engineering techniques to produce software, firmware, hardware, or any combination thereof. The term “article of manufacture” as used herein refers to code or logic implemented in hardware or non-transitory computer readable media such as optical storage devices, and volatile or non-volatile memory devices or transitory computer readable media such as signals, carrier waves, etc. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices.

What is claimed is:

1. A system for preheating building material for an additive manufacturing device, comprising:
a container comprising:
a reservoir configured to hold a portion of a building material held by a building material supply of the additive manufacturing device, the reservoir having a volume less than a volume of the building material supply;
a heating mechanism coupled to the reservoir for heating the portion of the building material; and
an actuation mechanism configured to deposit building material from the reservoir to at least one of a first side and a second side of a building platform of the additive manufacturing device.

2. The system of claim 1, wherein the actuation mechanism is further configured to cause the container to deposit building material on either side of a recoating mechanism of the additive manufacturing device.

3. The system of claim 2, wherein the container is configured to be coupled to the recoating mechanism and move along with the recoating mechanism between the first side and the second side of the building platform.

4. The system of claim 3, wherein the heating mechanism is configured to heat the portion of the building material while the recoating mechanism moves from the first side to the second side.

5. The system of claim 1, wherein the reservoir is positioned at one end of the container, and wherein the actuation mechanism is configured to tip the container along an axle at another end of the container to deposit the building material.

6. The system of claim 1, wherein the actuation mechanism is configured to selectively open one of a door or slot of the container to deposit the building material.

7. The system of claim 1, wherein the actuation mechanism is configured to deposit building material from the reservoir to both of the first side and the second side.

8. The system of claim 1, wherein the container further comprises a cooling mechanism coupled to the reservoir.

9. The system of claim 1, further comprising the building material supply, a scanning device, and a recoating mechanism.

10. A method for building an object using additive manufacturing, the method comprising:
depositing a first portion of building material from a building material supply into a reservoir of a container, the reservoir having a volume less than a volume of the building material supply;
heating the first portion of building material in the container;
depositing the heated first portion of building material from the reservoir on a first side of a building platform of an additive manufacturing device on a first side of a recoating mechanism closer to a second side of the building platform;
depositing a second portion of building material from the building material supply into the reservoir;
depositing from the first side of the building platform the heated first portion of building material onto the building platform to form a first layer of building material;
scanning the first layer of building material to form a first layer of the object;
heating the second portion of building material in the container;
depositing the heated second portion of building material from the reservoir on the second side of the building platform on a second side of the recoating mechanism closer to the first side of the building platform;
depositing from the second side of the building platform the heated second portion of building material onto the building platform to form a second layer of building material; and
scanning the second layer of building material to form a second layer of the object.

11. The method of claim 10, wherein heating the second portion of the building material and depositing from the first side of the building platform the heated first portion of building material are performed substantially in parallel.

12. The method of claim 10, wherein depositing from the first side of the building platform the heated first portion of building material comprises pushing the building material.

13. The method of claim 10, further comprising cooling the second portion of building material in the reservoir.

14. The method of claim 10, wherein scanning the first layer of building material and heating the second portion of the building material are performed substantially in parallel.

15. The method of claim 10, wherein depositing the heated first portion of building material from the reservoir on the first side of the recoating mechanism comprises tipping the container toward the first side of the recoating mechanism along an axle of the container.

16. The method of claim 10, further comprising tapping or shaking the container to loosen stuck building material in the reservoir.

17. A system for preheating building material for an additive manufacturing device, comprising:
means holding a portion of a building material held by a building material supply of the additive manufacturing device, the means for holding having a volume less than a volume of the building material supply;
means for heating the portion of the building material in the means for holding; and
means for depositing building material from the means for holding to at least one of a first side and a second side of a building platform of the additive manufacturing device.

18. The system of claim 17, wherein means for depositing is further configured to cause the means for holding to deposit building material on either side of a recoating mechanism of the additive manufacturing device.

19. The system of claim 18, wherein the means for holding is configured to be coupled to the recoating mechanism and move along with the recoating mechanism between the first side and the second side of the building platform.

20. The system of claim 19, wherein the means for heating is configured to heat the portion of the building material while the recoating mechanism moves from the first side to the second side.
